(19) United States
(12) Patent Application Publication
(10) Pub. No.: US 2012/0318887 A1
(43) Pub. Date: Dec. 20, 2012

(54) System And Method for Cooling a Fuel Injector

(75) Inventor: Edward Pan, Houston, TX (US)

(73) Assignee: GENERAL ELECTRIC COMPANY, Schenectady, NY (US)

(21) Appl. No.: 13/397,832

(22) Filed: Feb. 16, 2012

Related U.S. Application Data
(63) Continuation-in-part of application No. 13/162,623, filed on Jun. 17, 2011.

(51) Int. Cl. B05C 1/00

(52) U.S. Cl. 239/128

(57) ABSTRACT

A system includes a gasifier and a gasification fuel injector. The gasification fuel injector may include a tip portion, a coolant chamber disposed in the tip portion, and a number of internal structures disposed on an internal surface of the coolant chamber. The coolant chamber may be configured to flow a coolant through the tip portion of the gasification fuel injector.

### RELATED APPLICATIONS

The present application is a continuation-in-part of U.S. Ser. No. 13/162,623, filed on Jun. 17, 2011, entitled “FEED INJECTOR FOR GASIFICATION SYSTEM”. U.S. Ser. No. 13/162,623 is incorporated by reference herein in full.

### TECHNICAL FIELD

The subject matter disclosed herein relates to fuel injectors, and, more particularly, to fuel injectors for gasifiers.

### BACKGROUND OF THE INVENTION

A variety of combustion systems employ fuel injectors to inject a fuel into a combustion chamber. For example, an integrated gasification combined cycle (IGCC) power plant includes a gasifier with one or more fuel injectors. The fuel injectors supply a fuel, such as an organic feedstock, into the gasifier along with oxygen and steam to generate a syngas. In general, combustion occurs downstream from the fuel injectors. However, the proximity of a flame and/or heat from combustion can degrade and/or reduce the life of the fuel injectors, particularly if the fuel injectors exceed certain temperatures. For example, the fuel injector may be subject to increasing greater temperatures toward the tip and/or other locations close to the flame. Unfortunately, existing fuel injectors may be subject to premature wear caused by high stress and/or strain caused by the high temperatures within the gasifier.

### BRIEF DESCRIPTION OF THE INVENTION

Certain examples commensurate in scope with the originally claimed invention are summarized below. These examples are not intended to limit the scope of the claimed invention, but rather these examples are intended only to provide a brief summary of possible forms of the invention. Indeed, the invention may encompass a variety of forms that may be similar to or different from the examples set forth below.

In a first example, a system includes a gasifier and a gasification fuel injector. The gasification fuel injector may include a tip portion, a coolant chamber disposed in the tip portion, and a number of internal structures disposed on an internal surface of the coolant chamber.

In a second example, a system includes a gasifier or a reactor and a fuel injector. The fuel injector may include a fuel passage configured to inject a fuel, an oxygen passage configured to inject oxygen, an annular coolant chamber that may include an inner annular wall and an outer annular wall, and a number of internal structures disposed on an internal surface of the inner annular wall or the outer annular wall.

In a third example, a method includes injecting a fuel from a fuel passage disposed in a fuel injector into a reaction chamber, injecting oxygen from an oxygen passage disposed in the fuel injector into the reaction chamber, flowing a coolant through a coolant chamber disposed in a tip portion of the fuel injector. The coolant chamber includes a number of internal structures disposed on an internal surface of the coolant chamber.

### BRIEF DESCRIPTION OF THE DRAWINGS

These and other features, aspects, and advantages of the present application will become better understood when the following detailed description is read with reference to the accompanying drawings in which like characters represent like parts throughout the drawings, wherein:

FIG. 1 is a cross-sectional side view of a gasifier that includes an example of a fuel injector;

FIG. 2 is a partial axial cross-section of an example of the fuel injector of FIG. 1, taken within line 2-2, illustrating a number of internal structures coaxial about an axial axis of the fuel injector;

FIG. 3 is a partial axial cross-section of an example of the fuel injector of FIG. 1, taken within line 2-2, illustrating a number of internal structures aligned with a radial and/or axial axis of the fuel injector;

FIG. 4 is a partial axial cross-section of an example of the fuel injector of FIG. 1, taken within line 2-2, illustrating a first portion of a number of internal structures aligned with an axial axis of the fuel injector and a second portion of the number of internal structures aligned with a circumferential axis (e.g., coaxial about a longitudinal axis) of the fuel injector;

FIG. 5 is a partial cross-section of an example of the fuel injector of FIG. 1, taken within line 2-2, illustrating a number of internal structures configured as protrusions coaxial about an axial axis of the fuel injector; and

FIG. 6 is a partial axial cross-section of an example of a fuel injector with a coolant chamber that includes a number of internal structures.

### DETAILED DESCRIPTION OF THE INVENTION

One or more specific examples of the present application will be described below. In an effort to provide a concise description of these examples, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various examples of the present application, the articles “a,” “an,” “the,” and “said” are intended to mean that there are one or more of the elements. The terms “comprising,” “including,” and “having” are intended to be inclusive and mean that there may be additional elements other than the listed elements.

A combustion system may utilize fuel injectors to inject fuel, and optionally other fluids, into a combustion chamber. For example, an IGCC power plant may have a gasifier that includes one or more gasification fuel injectors. Because combustion occurs near a tip of the fuel injector, the tip may be exposed to temperatures up to approximately 1,300 degrees Celsius (C). In addition, hot combustion gases may recirculate back toward the fuel injector. Such high temperatures may degrade the fuel injector even though the injector is made from materials specifically designed for high temperatures. Accordingly, different cooling methods may be used to increase the life of fuel injectors. For example, fuel injector tips may have an integral coolant chamber through which a coolant may flow. However, when such methods are used without the disclosed cooling techniques, an outer surface of the fuel injector may be exposed to hot recirculated gases, while an inner surface of the fuel injector may be in contact with the coolant. For example, the temperature of the coolant may be approximately 40 degrees C., resulting in a temperature difference of approximately 1,260 degrees C. from the outer surface to the inner surface of the fuel injector. Such a large temperature gradient may result in cracks near the tip of the fuel injector. Specifically, the high temperatures and temperature fluctuations may cause radial cracks near the tip. In addition, high strain forces caused by the high temperature gradient may cause circumferential cracks. Thicker coolant chamber walls designed for increased strength may inhibit heat transfer, contributing to larger temperature gradients and cracks. Such cracks may reduce the life of the fuel injector.

To address these issues, in various examples described below, the fuel injector includes a number of internal structures disposed on an internal surface of an annular coolant chamber. The number of internal structures may induce turbulent flow of the coolant flowing through the annular coolant chamber. By inducing turbulent flow of the coolant, heat transfer across the annular coolant chamber walls may be increased, thereby reducing the temperature gradient across the wall. The number of internal structures also increases the surface area of the internal surface of the annular coolant chamber, thereby increasing the convective heat transfer across the wall of the chamber. By increasing the heat transfer across the wall, the temperature gradient across (or through) the wall may be reduced. In turn, the number of internal structures may help reduce thermal stress in the annular coolant chamber and increase flexibility of the annular coolant chamber. The decreased temperature gradient, reduced stress, increased flexibility, and reduced strain may help increase the life of the fuel injector by reducing the formation and/or frequency of thermal cracks and other degradation of the fuel injector. Furthermore, adding the number of internal structures to the annular coolant chamber may be mechanically simple, and may not promote excessive pressure loss of the coolant flowing through the annual cooling chamber.

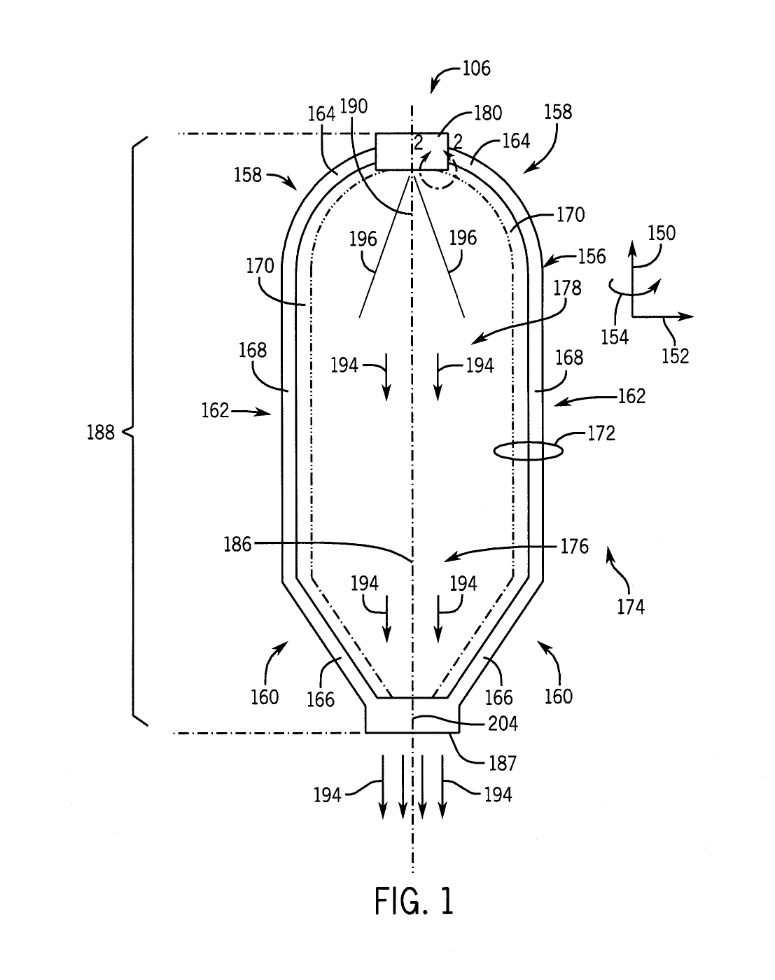

Turning now to the drawings, FIG. 1 is a cross-sectional side view of a gasifier 106 that includes an example of a fuel injector 180. In further examples, the fuel injector 180 may be disposed in similar devices, such as, but not limited to, a gas turbine engine, a combustion engine, a combustion system, a boiler, a reactor, a combustor, or any combination thereof As discussed in detail below, various examples of the fuel injector 180 may include a number of internal structures disposed on an internal surface of an annular coolant chamber of the fuel injector 180. The gasifier 106 may have an axial axis or direction 150, a radial axis or direction 152, and a circumferential axis or direction 154. The gasifier 106 includes an enclosure 156, also referred to as the shell, that functions as a housing or outer casing for the gasifier 106. The enclosure 156 includes a first end portion 158 and a second end portion 160. An intermediate portion 162 is defined by the section of the enclosure 156 that lies axially between the first end portion 158 and the second end portion 160. The first end portion 158 and the second end portion 160 include a dome-shaped top wall 164, and a triangular-shaped (e.g., conical shaped) bottom wall 166, respectively. A side wall 168 (e.g., annular side wall) parallel to the axis 150 is disposed in the intermediate portion 162 between the top wall 164 and the bottom wall 166.

The illustrated example also includes a thermal barrier 170 concentrically disposed inside the enclosure 156. The thermal barrier 170 and the enclosure 156 form a wall assembly 172 that separates an exterior 174 of the gasifier 106 from an interior 176 of the gasifier 106. The interior 176 includes a gasification chamber 178, or combustion chamber, where pyrolysis, combustion, gasification, or a combination thereof, may occur. The wall assembly 172 is configured to block heat transfer and leakage of gaseous components from the interior 176 to the exterior 174 during gasification. Additionally, the thermal barrier 170 may be configured to maintain the surface temperature of the enclosure 156 within a desired temperature range. Accordingly, the thermal barrier 170 may include passive shielding, active cooling, or a combination thereof. For example, the thermal barrier 170, or refractory insulating lining, may be made of any material that maintains its predetermined physical and chemical characteristics upon exposure to high temperatures.

In the example illustrated in FIG. 1, the fuel injector 180 is disposed in the top wall 164 of the first end portion 158 of the enclosure 156. The fuel injector 180 is longitudinally offset from an outlet 187 by a distance 188 and includes an injection axis 190 that determines the general orientation of the flow originating from the fuel injector 180. The fuel injector 180 may be configured to inject fuel, oxygen (e.g., air or any oxygen-containing mixture), cooling gas (e.g., carbon dioxide, nitrogen, or a flame resistant gas), or a mixture of fuel, oxygen, and cooling gas into the gasification chamber 178. For instance, the fuel injector 180 may inject fuel in the form of a carbonaceous feedstock, such as coal, petroleum, or biomass. In fact, the fuel injector 180 may inject any material suitable for the production of synthetic gas, or syngas, via gasification (e.g., organic materials, such as wood or plastic waste). In certain examples, the fuel may be a liquid slurry, such as a coal slurry. In other examples, the fuel injector 180 may inject a controlled amount of oxygen and/or steam either alone or in combination with a suitable fuel. In specific examples, the fuel injector 180 may include one or more passages. For example, the fuel injector 180 may include one or more fuel passages to inject the fuel and one or more oxygen passages to inject the oxygen.

In the illustrated example, the injection axis 190 is parallel to the axis 150 and perpendicular to the radial axis 152 of the gasifier 106. In other words, the injection axis 190 is parallel to a longitudinal axis 186. Such a feature has the effect of directing a fluid flow emerging from the fuel injector 180 in a generally downward direction (e.g., downstream flow direction), as indicated by arrows 194, through the gasification chamber 178 during use. In certain examples, the injection axis 190 may be directed away from the longitudinal axis 186 by an angle between approximately 0 to 45, 0 to 30, 0 to 20, or 0 to 10 degrees. Furthermore, certain examples of the fuel injector 180 may provide a divergent spray, e.g., fluid flow originating from the fuel injector 180 may diverge outward toward the side walls 168 in a generally downward direction (e.g., downstream flow direction), as indicated by reference numeral 196.

In the illustrated example of the gasifier 106, the resultant syngas emerges from the gasifier 106 via outlet 187 along a path generally defined by outlet axis 204. That is, the syngas exits the gasifier 106 via a location in the bottom wall 166 of the gasifier 106. However, it should be noted that the gasifier design disclosed herein may be used with a variety of other gasification systems wherein the outlet is not disposed in a bottom wall. For instance, the disclosed examples may be used in conjunction with entrained flow gasifiers. In such examples, the direction of flow through the gasification chamber 178 may be upward through the gasifier 106, i.e., in a direction opposite arrows 194. In these systems, the resultant syngas may exit an outlet located on or near the top wall 164 of the gasifier 106, while the molten slag may exit through the bottom wall 166. For further example, the disclosed examples may be employed in fluidized bed gasifiers. Likewise, the outlet in such devices may be located near the top wall 164 of the gasifier 106 since the direction of flow is generally upward.

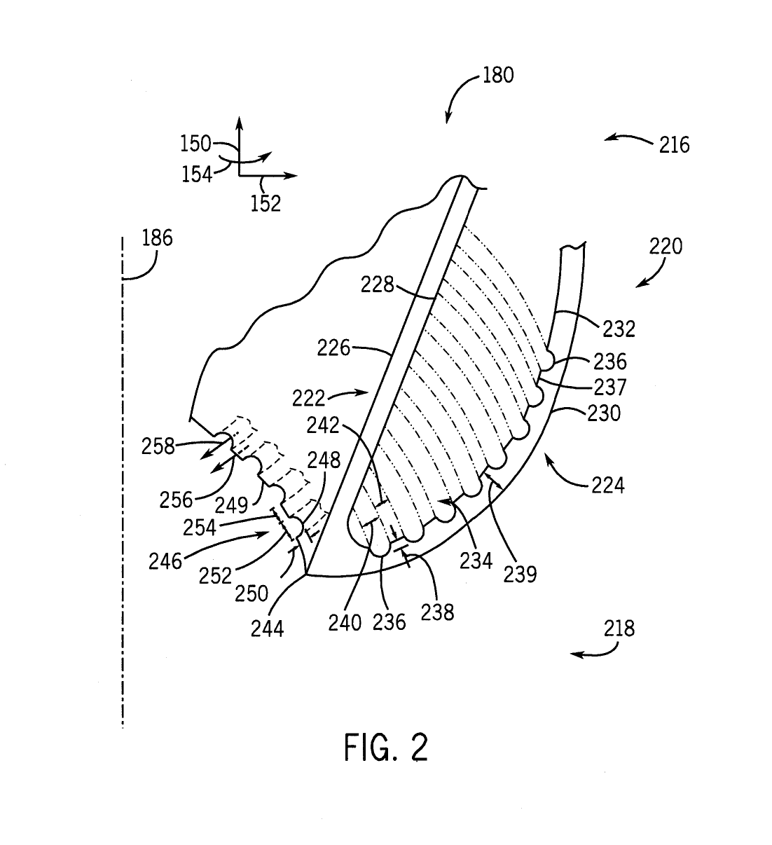

FIG. 2 is a partial axial cross-section of the fuel injector 180 of FIG. 1, taken within line 2-2, in accordance with an example. As shown in FIG. 2, the longitudinal axis 186 passes through the center of the fuel injector 180 and is aligned with the axial axis 150. The fuel injector 180 has an upstream side 216, from which the feedstock, oxygen, cooling gas, and other materials may originate. The fuel injector 180 also has a tip 218, where the feedstock, oxygen, cooling gas, and other materials may exit. Thus, the tip 218 is an outlet for the materials. As shown in FIG. 2, the fuel injector 180 includes an annular coolant chamber 220 disposed in the tip 218. A coolant (e.g., liquid and/or gas) may flow through the annular coolant chamber 220 to help cool the tip 218. Examples of coolants include, but are not limited to, water, steam, carbon dioxide, and nitrogen. However, the coolant may include a suitable coolant gas, coolant liquid, coolant mixture, or any combination thereof. As each of these materials have different heat transfer characteristics, a particular coolant may be selected depending on the particular cooling requirement of the fuel injector 180. By absorbing the heat from the hot combustion gases and carrying the heat away from the fuel injector 180, the annular coolant chamber 220 helps to protect the tip 218 from high temperature degradation.

The annular coolant chamber 220 shown in FIG. 2 may include an inner annular wall 222 and an outer annular wall 224. The inner annular wall 222 may be in contact with the materials flowing through the fuel injector 180, and the outer annular wall 224 may be in contact with the hot combustion gases. Because of the different temperatures of the materials flowing through the fuel injector 180 and the hot combustion gases, a temperature of the inner annular wall 222 may be less than a temperature of the outer annular wall 224. The inner annular wall 222 may include an external surface 226 and an internal surface 228 relative to the coolant chamber 220. The external surface 226 may be in contact with the materials flowing through the fuel injector 180, and the internal surface 228 may be in contact with the coolant flowing though the annular coolant chamber 220. Similarly, the outer annular wall 224 may include an external surface 230 and an internal surface 232 relative to the coolant chamber 220. The external surface 230 may be in contact with the hot combustion gases, and the internal surface 232 may be in contact with the coolant flowing through the annular coolant chamber 220.

As shown in FIG. 2, a number of internal structures 234 may be disposed on the internal surface 232 of the outer annular wall 224. In the illustrated example, the number of internal structures 234 includes arcuate grooves 236 and raised portions 237 that are co-axial about the longitudinal axis 186. In other words, the annular grooves 236 and annular raised portions 237 may encircle the longitudinal axis 186 in the circumferential direction 154. In other examples, the annular grooves 236 and annular raised portions 237 may be separate or connected to one another (e.g., spiraling about the longitudinal axis 186 in both the circumferential and axial directions 154 and 150). In the illustrated example, the grooves 236 have a half circle cross-sectional shape. In other examples, the cross-sectional shape of the grooves 236 may be a portion of a circle, an oval, a square, a rectangle, a polygon, or any combination thereof. Specifically, the cross-sectional shape of the grooves 236 may be selected to induce turbulent flow of the coolant flowing through the annular coolant chamber 220. For example, the coolant flowing in the axial direction 150 through the annular coolant chamber 220 may become turbulent as the coolant moves across each of the grooves 236 and raised portions 237. In addition, the grooves 236 may be defined by a depth 238 relative to the raised portions 237. Grooves 236 with a greater depth 238 may induce more turbulence of the coolant compared to grooves 236 with a smaller depth 238. In addition, the depth 238 may be less than an outer annular wall thickness 239. Thus, the groove 236 does not extend through the outer annular wall 224. In certain examples, the depth 238 may be between approximately 20 to 80 percent, 30 to 70 percent, or 40 to 50 percent of the outer annular wall thickness 239. In addition, the grooves 236 may be defined by a width 240, which may be selected to provide a desired amount of turbulence of the coolant. Each of the grooves 236 may be separated by a separation distance 242 (e.g., width of raised portions 237), which may also be selected to provide a desired amount of turbulence of the coolant. In certain examples, the grooves 236 and raised portions 237 may be disposed along all of part of the internal surface 232 of the outer annular wall 224. In further examples, the grooves 236 and raised portions 237 may be disposed along all or part of the internal surface 228 of the inner annular wall 222. In yet further examples, the grooves 236 and raised portions 237 may be disposed along all or part of both of the inner surfaces 228 and 232. In addition, the shape of the grooves 236 and raised portions 237, the depth 238, width 240, and separation distance 242 may be adjusted to maintain the pressure drop of the coolant flowing through the annular coolant chamber 220 below a threshold. The grooves 236 and raised portions 237 shown in FIG. 2 may also increase the surface area of one or both of the internal surfaces 228 and 232, which may increase the convective heat transfer across one or both of the inner and outer annular walls 222 and 224. In addition, the grooves 236 and raised portions 237 may help to reduce the temperature gradient across the thickness 239 of the outer annular wall 224 or the inner annular wall 222, thereby helping to reduce thermal stress and thermal cracking of the fuel injector 180.

As shown in FIG. 2, in certain examples, the fuel injector 180 may include a number of external structures 246 disposed on the external surface 230 of the outer annular wall 224. In other examples, the number of external structures 246 may be disposed on one or both of the external surfaces 226 and 230. Specifically, the number of external structures 246 may extend in the axial direction 150 and/or the radial direction 152 from an annular edge 244 formed at the intersection of the outer surfaces 226 and 230. In other words, each of the number of external structures 246 may be aligned with (or at an angle to) a plane passing through the radial and axial axes 152 and 150 of the fuel injector 180. In other examples, the number of external structures 246 may be aligned at an angle with the radial axis 152 of the fuel injector 180. In the illustrated example, the number of external structures 246 may include radial grooves 248 and raised portions 249. As with the annular grooves 236, the cross-sectional shape of the radial grooves 248 may include a portion of a circle, an oval, a square, a rectangle, a polygon, or any combination thereof. In addition, the radial grooves 248 may be defined by a depth 250 and a width 252, which may be selected to help reduce stress in the tip 218, reduce strain in the tip 218, increase a heat transfer coefficient of the tip 218, increase flexibility of the tip 218, or any combination thereof. In other words, the radial grooves 248 may help reduce stress and/or strain in the circumferential direction 154, thereby reducing cracking and other degradation of the tip 218. In addition, the radial grooves 248 and raised portions 249 may direct the flow of the materials exiting from the tip 218, thereby helping to create a chevron-type (or V-shaped type) of fluid injection pattern downstream of the fuel injector 180. Further, the radial grooves 248 may be separated by a separation distance 254 (e.g., width of raised portions 249), which may be selected to adjust the pattern of the material exiting from the tip 218. For example, a first portion 256 of the materials flowing through the fuel injector 180 may flow in the spaces between the grooves 248, and a second portion 258 of the materials may flow through the radial grooves 248. The velocities of the materials flowing through the first and second portions 256 and 258 may be different from one another, thereby creating the chevron-type (or V-shaped type) of fluid injection pattern. The grooves 248 and raised portions 249 shown in FIG. 2 may also increase the surface area of one or both of the external surfaces 226 and 230, which may increase the convective heat transfer across one or both of the inner and outer annular walls 222 and 224. In addition, the grooves 248 and raised portions 249 may help to reduce the temperature gradient across the thickness 239 of the outer annular wall 224 or the inner annular wall 222, thereby helping to reduce thermal stress and thermal cracking of the fuel injector 180.

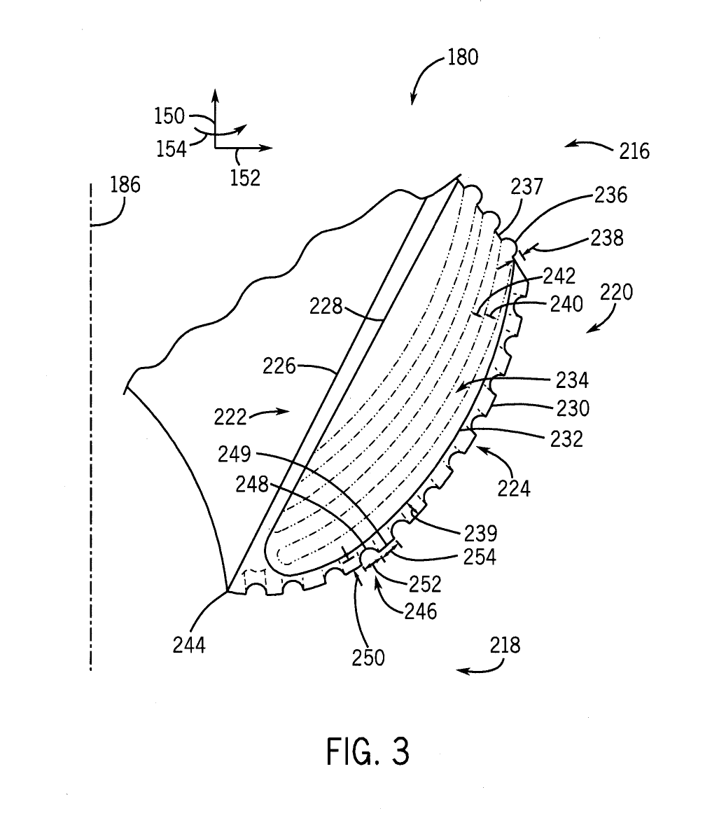

FIG. 3 is a partial axial cross-section of the fuel injector 180 of FIG. 1, taken within line 2-2, in accordance with an example. In the illustrated example, each of the number of internal structures 234 is aligned with the radial axis 152 and/or axial axis 150. Thus, the number of internal structures 234 may induce turbulent flow of the coolant flowing through the annular coolant chamber 220 in the circumferential direction 154 about the axis 186. In other examples, the number of internal structures 234 may be aligned at an angle with the radial axis 152 of the fuel injector 180. In other words, the number of internal structures 234 may be at an angle to a plane passing through the radial and axial axes 152 and 150 of the fuel injector 180. In further examples, the number of internal structures 234 may be disposed on one or both of the internal surfaces 228 and 232. In addition, the number of external structures 246 is arcuate and coaxial about the axial axis 150. In certain examples, the annular grooves 248 and annular raised portions 249 that encircle the longitudinal axis 186 may be separate or connected to one another (e.g., a spiraling groove 248 and a spiraling raised portion 249 that both extend in the axial and circumferential directions 150 and 154). Thus, the number of external structures 246 may induce turbulent flow of the hot combustion gases flowing along the external surface 230 of the outer annular wall 224, thereby increasing the heat transfer coefficient of the outer annular wall 224. In other examples, the number of external structures 246 may be disposed on one or both of the external surfaces 226 and 230. The grooves 236 and 248 and raised portions 237 and 249 shown in FIG. 3 may also increase the surface area of internal surfaces 228 and 232 and/or external surfaces 226 and 230, which may increase the convective heat transfer across one or both of the inner and outer annular walls 222 and 224. In addition, the grooves 236 and 248 and raised portions 237 and 249 may help to reduce the temperature gradient across the thickness 239 of the outer annular wall 224 or the inner annular wall 222, thereby helping to reduce thermal stress and thermal cracking of the fuel injector 180.

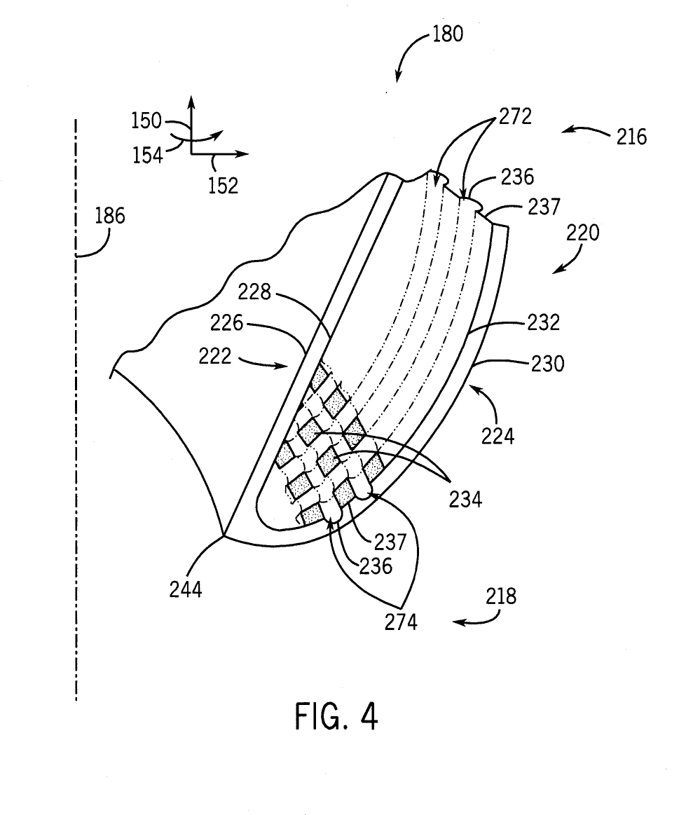

FIG. 4 is a partial axial cross-section of the fuel injector 180 of FIG. 1, taken within line 2-2, in accordance with an example. As shown in FIG. 4, the fuel injector 180 includes a number of internal structures 234 disposed on the internal surface 232. Specifically, the number of internal structures 234 may be formed from the intersection of two portions of crosswise grooves 236 and raised portions 237 aligned with the axial axis 150 and the circumferential axis 154. In other words, a first portion 272 of the grooves 236 may be aligned with the axial axis 150, and a second portion 274 of the grooves 236 may encircle the axial axis 154 in the circumferential direction 154. The second portion 274 of the grooves 236 may also be arcuate and coaxial about the axial axis 150. Thus, the number of internal structures 234 may be formed where the grooves 236 do not intersect. As shown in FIG. 4, the internal surface 232 has a waffle iron or grid appearance. In other words, the number of internal structures 234 may be described as a grid of bumps or protrusions of the internal surface 232. The internal surface 232 may also be described as having first and second sets of internal structures 234 that are oriented crosswise to one another. Such a configuration of the internal surface 232 may induce additional turbulence of the coolant flowing through the annular coolant chamber 220. In other examples, the number of internal structures 234 may be aligned at an angle with the axial axis 150, the radial axis 152, or the circumferential axis 154 of the fuel injector 180. In general, the number of internal structures 234 may include at least one of a groove, channel, slot, fin, bump, protrusion, or any combination thereof. As shown in FIG. 4, each of the internal structures 234 has a square or rectangular shape. However, in other examples, the number of internal structures 234 may have other shapes depending on the alignment of the grooves 236 with the axial axis 150. In further examples, the number of internal structures 234 may be located on one or both of the internal surfaces 228 and 232. The grooves 236 and raised portions 237 shown in FIG. 4 may also increase the surface area of one or both of the internal surfaces 228 and 232, which may increase the convective heat transfer across one or both of the inner and outer annular walls 222 and 224. In addition, the grooves 236 and raised portions 237 may help to reduce the temperature gradient across the thickness 239 of the outer annular wall 224 or the inner annular wall 222, thereby helping to reduce thermal stress and thermal cracking of the fuel injector 180.

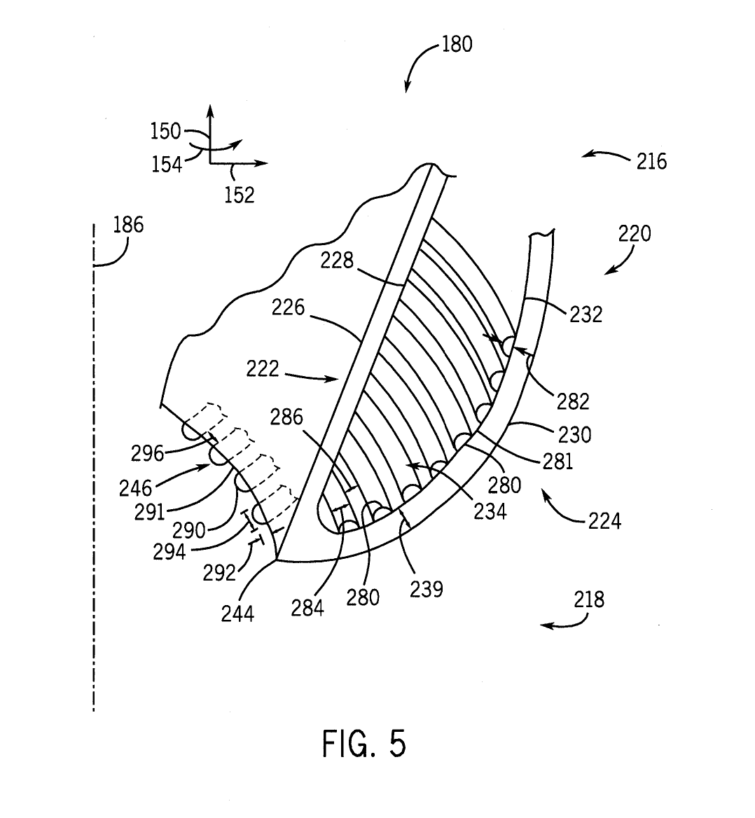

FIG. 5 is a partial axial cross-section of the fuel injector 180 of FIG. 1, taken within line 2-2, in accordance with an example. As shown in FIG. 5, the fuel injector 180 includes a number of internal structures 234 that are configured as annular protrusions 280 and recessed portions 281 that extend along the annular coolant chamber 220. A cross-sectional shape of each of the annular protrusions 280 may include a portion of a circle, an oval, a square, a rectangle, a polygon, or any combination thereof. Each of the annular protrusions 280 may be defined by a height 282 and a width 284, which may be selected to provide a desired amount of turbulence to the coolant flowing through the annular coolant chamber 220. In addition, each of the annular protrusions 280 may be separated by a separation distance 286 (e.g., width of recessed portions 281). As shown in FIG. 5, the annular protrusions 280 and recessed portions 281 encircle the longitudinal axis 186 in the circumferential direction 154. In other examples, the number of internal structures 234 may be aligned with the axial axis 152 or aligned at an angle to either the radial axis 152 or the axial axis 150. In further examples, the number of internal structures 234 may be disposed on one or both of the internal surfaces 228 and 232. In yet further examples, the number of internal structures 234 may include a number of elongated grooves 236 and/or elongated raised portions 249, a grid of recesses 281 and/or protrusions 280, or any combination thereof

In addition, the fuel injector 180 shown in FIG. 5 includes a number of external structures 246 configured as protrusions 290 and recesses 291. Specifically, the protrusion 290 may be aligned with the axial axis 150. Each of the protrusions 290 may be defined by a height 292 and a width 294, which may be selected to provide desired heat transfer coefficients of the outer annular wall 224. In addition, the protrusions 290 may be separated from one another by a separation distance 296 (e.g., width of recesses 291). In other examples, the protrusions 290 may be annular and coaxial about the axial axis 150 or aligned at an angle to either the radial axis 152 or the axial axis 150. The protrusions 290 may help induce turbulent flow of the hot combustion gases flowing along the external surface 230 of the outer annular wall 224, thereby increasing the heat transfer coefficient of the outer annular wall 224. The protrusions 290 and recesses 291 shown in FIG. 5 may also increase the surface area of internal surfaces 228 and 232 and/or external surfaces 226 and 230, which may increase the convective heat transfer across one or both of the inner and outer annular walls 222 and 224. In addition, the protrusions 290 and recesses 291 may help to reduce the temperature gradient across the thickness 239 of the outer annular wall 224 or the inner annular wall 222, thereby helping to reduce thermal stress and thermal cracking of the fuel injector 180.

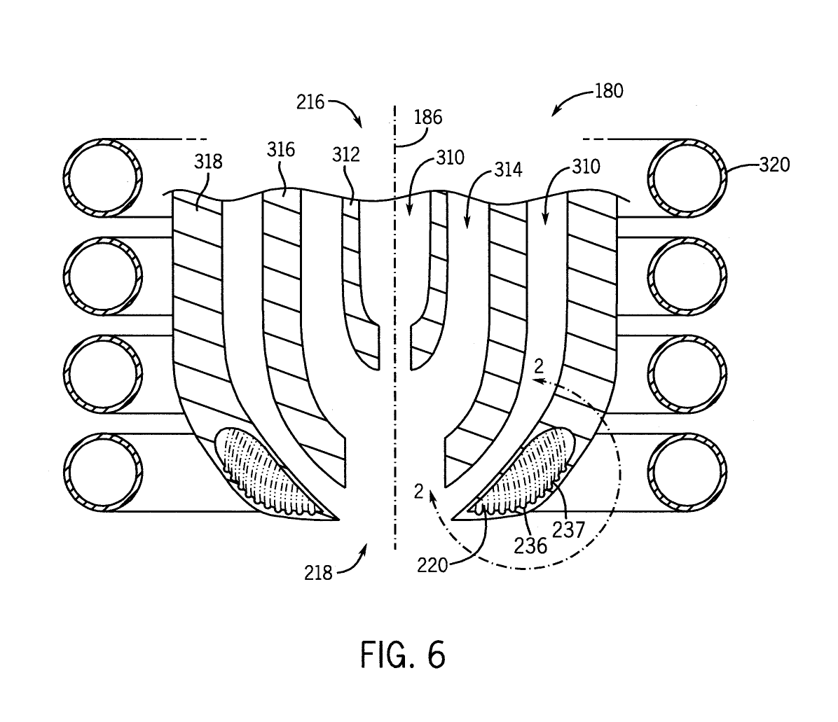

FIG. 6 is a partial axial cross-section of an example of the fuel injector 180 with the annular coolant chamber 220. As shown in FIG. 6, the annular coolant chamber 220 includes the number of arcuate grooves 236 and raised portions 237 and is integral or one-piece with the tip 218. In addition, the fuel injector 180 includes a number of passages. Although one arrangement of passages will be described, other arrangements are possible depending on the requirements of a particular combustion system. Specifically, the innermost material passing through the fuel injector 180 is oxygen 310, which is directed to the tip 218 by a first oxygen passage 312. The first oxygen passage 312 supplies oxygen 310 for combustion downstream of the tip 218 of the fuel injector 180. Oxygen 310 may include, but is not limited to, pure oxygen, oxygen mixtures, and air. The next outermost material is a fuel 314, which is directed to the tip 218 by a fuel passage 316. Thus, the fuel passage 316 surrounds the first oxygen passage 312 in a coaxial or concentric arrangement. The fuel 314 may include a dry fuel, a slurry fuel, a liquid fuel, or any combination thereof. The fuel passage 316 directs the fuel 314 just downstream of oxygen 310 from the first oxygen passage 312 to enhance the mixing of the fuel and oxygen. The next outermost material is oxygen 310, which is directed to the tip 218 of the fuel injector 180 by a second oxygen passage 318. Thus, the second oxygen passage 318 surrounds the fuel passage 316 in a coaxial or concentric arrangement. The second oxygen passage 318 may direct oxygen 310 to the mixture of the fuel 314 and oxygen from the first oxygen passage 312 to produce a fine spray for efficient combustion. The oxygen 310 from the second oxygen passage 318 may also include, but is not limited to, pure oxygen, oxygen mixtures, and air. As shown in FIG. 6, the annular coolant chamber 220 may be formed in the second oxygen passage near the tip 218 of the fuel injector 180. In certain examples, the passages 312, 316, and 318 may be converging or angled toward the longitudinal axis 186 to direct material to the tip 218 and the annular coolant chamber 220 may be disposed in the converging portions of the passages 312, 316, and 318 near the tip 218. In further examples, the coolant may enter a cooling coil 320 near the upstream side 216 of the fuel injector 180. The coolant then circulates through the coil 320 until it enters the annular coolant chamber 220 near the tip 218. Thus, the cooling coil 320 may be disposed external from the annular coolant chamber 220 and the fuel injector 180.

As described above, certain examples of the fuel injector 180 may include the tip 218, the annular coolant chamber 220, and the number of internal structures 234 disposed on the internal surfaces 228 and 232 at the annular coolant chamber 220. The number of internal structures 234 may induce turbulent flow of the coolant flowing through the annular coolant chamber 220, thereby improving heat transfer across the outer annular wall 224. The improved heat transfer across the outer annular wall 224 may help increase the life of the fuel injector 180 by decreasing stress, decreasing strain, and/or increasing flexibility of the tip 218. Thus, the formation of cracks in the tip 218 may be reduced. In further examples, the fuel injector 180 may include the number of external structures 246 disposed on external surfaces 226 and 230 of the annular coolant chamber 220. The number of external structures 246 may also help increase the life of the fuel injector 180.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

I claim:

1. A system, comprising:
a gasifier; and
a gasification fuel injector, comprising:
a tip portion;
a coolant chamber disposed in the tip portion; and
a plurality of internal structures disposed on an internal surface of the coolant chamber.

2. The system of claim 1, comprising a plurality of external structures disposed on an external surface of the coolant chamber, wherein the plurality of external structures or the plurality of internal structures are configured to reduce stress in the tip portion, reduce strain in the tip portion, increase a heat transfer coefficient of the tip portion, or increase flexibility of the tip portion, or any combination thereof, or wherein the plurality of internal structures is configured to induce turbulent flow of a coolant flowing through the coolant chamber.

3. The system of claim 1, wherein the plurality of internal structures extends in, or aligns with, a radial direction or an axial direction relative to a central axis of the gasification fuel injector.

4. The system of claim 1, wherein the plurality of internal structures extends in, or aligns with, a circumferential direction about a central axis of the gasification fuel injector.

5. The system of claim 1, wherein the plurality of internal structures comprises first and second sets of internal structures that are oriented crosswise to one another.

6. The system of claim 1, wherein each of the plurality of internal structures comprises at least one of a recess, a protrusion, or any combination thereof.

7. The system of claim 1, wherein the plurality of internal structures comprises a plurality of elongated grooves and/or elongated raised portions, a grid of recesses and/or protrusions, or a combination thereof.

8. A system, comprising:
a reactor or a gasifier; and
a fuel injector, comprising:
a fuel passage configured to inject a fuel;
an oxygen passage configured to inject oxygen;
an annular coolant chamber comprising an inner annular wall and an outer annular wall; and
a plurality of internal structures disposed on an internal surface of the inner annular wall or the outer annular wall.

9. The system of claim 8, comprising a plurality of external structures disposed on an external surface of the inner annular wall or the outer annular wall, wherein the plurality of external structures or the plurality of internal structures are configured to reduce stress in the fuel injector, reduce strain in the fuel injector, increase a heat transfer coefficient of the tip portion, or increase flexibility of the fuel injector, or any combination thereof, or wherein the plurality of internal structures is configured to induce turbulent flow of a coolant flowing through the annular coolant chamber.

10. The system of claim 8, wherein the plurality of internal structures extends in, or aligns with, a radial direction or an axial direction relative to a central axis of the fuel injector.

11. The system of claim 8, wherein the plurality of internal structures extends in, or aligns with, a circumferential direction about a central axis of the fuel injector.

12. The system of claim 8, wherein the plurality of internal structures comprises first and second sets of internal structures that are oriented crosswise to one another.

13. The system of claim 8, wherein each of the plurality of internal structures comprises at least one of a groove, channel, slot, fin, bump, or protrusion, or any combination thereof, and wherein a cross-sectional shape of each of the plurality of internal structures comprises at least one of a portion of a circle, an oval, a square, a rectangle, or a polygon, or a combination thereof.

14. A method, comprising:
injecting a fuel from a fuel passage disposed in a fuel injector into a reaction chamber;
injecting oxygen from an oxygen passage disposed in the fuel injector into the reaction chamber; and
flowing a coolant through a coolant chamber disposed in a tip portion of the fuel injector, wherein the coolant chamber comprises a plurality of internal structures disposed on an internal surface of the coolant chamber.

15. The method of claim 14, comprising at least one of reducing stress in the tip portion, reducing strain in the tip portion, increasing a heat transfer coefficient of the tip portion, or increasing flexibility of the tip portion, or any combination thereof using the plurality of internal structures or a plurality of external structures disposed on an external surface of the coolant chamber, or inducing turbulent flow of the coolant flowing through the coolant chamber using the plurality of internal structures.

16. The method of claim 14, wherein the plurality of internal structures extends in, or aligns with, a radial direction or an axial direction relative to a central axis of the gasification fuel injector, a circumferential direction about a central axis of the gasification fuel injector, or both.

17. The method of claim 14, wherein the plurality of internal structures comprises a plurality of elongated grooves and/or elongated raised portions, a grid of recesses and/or protrusions, or a combination thereof.

18. The method of claim 14, comprising gasifying the fuel in a reactor or a gasifier.
